(19) United States
(12) Patent Application Publication
(10) Pub. No.: US 2024/0203170 A1
(43) Pub. Date: Jun. 20, 2024

(54) IN-VEHICLE DEVICE, DATA GENERATION METHOD, STORAGE MEDIUM STORING DATA GENERATION PROGRAM, VEHICLE SYSTEM AND IN-VEHICLE SYSTEM

(71) Applicant: DENSO CORPORATION, Kariya-city (JP)

(72) Inventors: Makoto MANABE, Kariya-city (JP); Shigeru KAJIOKA, Kariya-city (JP); Makiko Tauchi, Kariya-city (JP); Masato Miyake, Kariya-city (JP)

(21) Appl. No.: 18/397,647

(22) Filed: Dec. 27, 2023

Related U.S. Application Data
(63) Continuation of application No. PCT/JP2022/026474, filed on Jul. 1, 2022.

(30) Foreign Application Priority Data
Jul. 2, 2021 (JP) 2021-110907

(51) Int. Cl. G07C 5/00

(52) U.S. Cl. CPC G07C 5/008

(57) ABSTRACT

An in-vehicle device mounted in a vehicle includes: at least one processor; and at least one memory storing computer program code. The computer program code, when executed by the at least one processor, causes the at least one processor to serve as a unit that is configured to communicate data with a center configured to manage vehicle data. The unit includes: a normalization portion that is configured to normalize a plurality of pieces of the vehicle data acquired from an electronic control unit mounted in the vehicle; a data structuring portion that is configured to structure the plurality of pieces of the vehicle data that are normalized by the normalization portion into a predetermined data structure; and a data transmission portion that is configured to transmit the plurality of pieces of the vehicle data that are structured by the data structuring portion to the center through a communicator.

### CROSS REFERENCE TO RELATED APPLICATIONS

This application is a continuation application of International Patent Application No. PCT/JP2022/026474 filed on Jul. 1, 2022, which designated the U.S. and claims the benefit of priority from Japanese Patent Application No. 2021-110907 filed on Jul. 2, 2021. The entire disclosure of all the above applications is incorporated herein by reference.

### TECHNICAL FIELD

The present disclosure relates to an in-vehicle device acquiring vehicle data, a data generation method, a storage medium storing a data generation program, a vehicle system, and an in-vehicle system.

### BACKGROUND

Digital twin simulation in which a state of a vehicle in a real world is reproduced in a virtual space by collecting vehicle data from the vehicle is known.

### SUMMARY

An in-vehicle device according to an aspect of the present disclosure includes: at least one processor; and at least one memory storing computer program code. The computer program code, when executed by the at least one processor, causes the at least one processor to serve as a unit that is configured to communicate data with a center configured to manage vehicle data. The unit includes: a normalization portion that is configured to normalize a plurality of pieces of the vehicle data acquired from an electronic control unit mounted in the vehicle; a data structuring portion that is configured to structure the plurality of pieces of the vehicle data that are normalized by the normalization portion into a predetermined data structure; and a data transmission portion that is configured to transmit the plurality of pieces of the vehicle data that are structured by the data structuring portion to the center through a communicator.

### BRIEF DESCRIPTION OF DRAWINGS

FIG. 1 is a block diagram showing a configuration of a mobility IoT system.

FIG. 2 is a block diagram showing a configuration of a data collection device.

FIG. 3 is a block diagram showing a configuration of a management center.

FIG. 4 is a functional block diagram showing a functional configuration of a data collection device.

FIG. 5 is a functional block diagram showing a functional configuration of the management center.

FIG. 6 is a drawing showing a configuration of a CAN frame.

FIG. 7 is a flowchart showing data standardization processing.

FIG. 8 is a drawing showing a configuration of a vehicle data conversion table.

FIG. 9 is a drawing showing a first layer of standardized vehicle data and a data format thereof.

FIG. 10 is a drawing showing a configuration of standardized vehicle data.

FIG. 11 is a sequence diagram showing a data preparation procedure for standardized vehicle data.

FIG. 12 is a flowchart showing the former part of data transmission processing.

FIG. 13 is a flowchart showing the latter part of data transmission processing.

FIG. 14 is a timing chart showing data transmission timing.

FIG. 15 is a functional block diagram showing a functional configuration of a mobility GW and a data management portion.

FIG. 16 is a drawing showing a configuration of a shadow.

FIG. 17 is a drawing showing a configuration of a latest index.

FIG. 18 is a drawing showing a configuration of an index.

FIG. 19 is a drawing illustrating a concrete example of a request.

FIG. 20 is a block diagram showing a connection state of ECU mounted in a vehicle.

FIG. 21 is a block diagram showing a mounting position of an access API in a data collection device.

### DESCRIPTION OF EMBODIMENTS

To begin with, a description will be given to a technology related to the present application for the sake of understanding of the following embodiments. Vehicle data acquired by in-vehicle network communication, such as CAN communication, does not have a data format usable for users utilizing the vehicle data. This is because data placed in a CAN communication frame differs, for example, from vehicle manufacturer to vehicle manufacturer, from car model to car model, or according to shipping timing. As a result of detailed consideration, the present inventors et al. found a problem that a user desiring to handle vehicle data is required of technical knowledge such as those related to a structure of a CAN communication frame corresponding to each vehicle and cannot easily access the vehicle data.

The present disclosure facilitates vehicle data utilization.

An aspect of the present disclosure is an in-vehicle device including: at least one processor; and at least one memory storing computer program code. The computer program code, when executed by the at least one processor, causes the at least one processor to serve as a unit that is configured to communicate data with a center configured to manage vehicle data. The unit includes: a normalization portion that is configured to normalize a plurality of pieces of the vehicle data acquired from an electronic control unit mounted in the vehicle; a data structuring portion that is configured to structure the plurality of pieces of the vehicle data that are normalized by the normalization portion into a predetermined data structure; and a data transmission portion that is configured to transmit the plurality of pieces of the vehicle data that are structured by the data structuring portion to the center through a communicator.

The above-described in-vehicle device according to the present disclosure standardizes a plurality of pieces of acquired vehicle data and is thus capable of providing a center with vehicle data in a format independent of, for example, vehicle manufacturer, car model, or shipping timing. Further, an in-vehicle device according to the present disclosure structures a plurality of pieces of standardized vehicle data in a preset data structure; therefore, a plurality of pieces of vehicle data can be accessed by a data name of specific vehicle data or a category name of a specific category. Because of the foregoing, an in-vehicle device according to the present disclosure can facilitate vehicle data utilization.

An aspect of the present disclosure is a data generation method implemented by an in-vehicle device that is mounted in a vehicle and includes a unit that is configured to communicate data with a center configured to manage vehicle data. The method includes: normalizing a plurality of pieces of the vehicle data acquired from an electronic control unit mounted in the vehicle; structuring the plurality of pieces of the vehicle data that are normalized into a predetermined data structure; and transmitting, with the unit, the plurality of pieces of the vehicle data that are structured to the center through a communicator.

A data generation method according to the present disclosure is a method performed in an in-vehicle device according to the present disclosure and the same effect as by an in-vehicle device according to the present disclosure can be brought about by performing the method.

Another aspect of the present disclosure is a non-transitory, tangible storage medium for storing a data generation program for an in-vehicle device that is mounted in a vehicle and includes a unit that is configured to communicate data with a center configured to manage vehicle data. The data generation program, when executed by a computer of the in-vehicle device, causes the computer to: normalize a plurality of pieces of the vehicle data acquired from an electronic control unit mounted in the vehicle; structure the plurality of pieces of the vehicle data that are normalized into a predetermined data structure; and cause the unit to transmit the plurality of pieces of the vehicle data that are structured to the center through a communicator.

A computer controlled by a data generation program according to the present disclosure can constitute a part of an in-vehicle device according to the present disclosure and the same effect as by the in-vehicle device according to the present disclosure can be brought about.

Another aspect of the present disclosure is a vehicle system including: a center that is configured to manage vehicle data transmitted from a plurality of vehicles; and a plurality of in-vehicle devices that are configured to wirelessly communicate with the center through a communicator. Each of the plurality of in-vehicle devices includes: at least one processor; and at least one memory storing computer program code. The computer program code, when executed by the at least one processor, causes the at least one processor to serve as a unit that is configured to communicate data with the center. The unit includes: a normalization portion that is configured to normalize a plurality of pieces of the vehicle data acquired from an electronic control unit mounted in the vehicle; a data structuring portion that is configured to structure the plurality of pieces of the vehicle data that are normalized by the normalization portion into a predetermined data structure; and a data transmission portion that is configured to transmit the plurality of pieces of the vehicle data that are structured by the data structuring portion to the center through the communicator. The center includes: a data receiving portion that is configured to receive the plurality of pieces of the structured vehicle data transmitted from the plurality of in-vehicle devices; and a vehicle data storage portion that is configured to store, for each of the plurality of vehicles, the plurality of pieces of the vehicle data that are structured by the data structuring portion and received by the data receiving portion.

A thus configured vehicle system according to the present disclosure is a system provided with an in-vehicle device according to the present disclosure and the same effect as by the in-vehicle device according to the present disclosure can be brought about.

Another aspect of the present disclosure is an in-vehicle system including: an electronic control unit that is mounted in a vehicle and is configured to transmit vehicle data; an in-vehicle device that is configured to acquire the vehicle data transmitted from the electronic control unit. The in-vehicle device includes: at least one processor; and at least one memory storing computer program code. The computer program code, when executed by the at least one processor, causes the at least one processor to serve as a unit that is configured to communicate data with a center configured to manage vehicle data. The unit includes: a normalization portion that is configured to normalize a plurality of pieces of the vehicle data acquired from the electronic control unit mounted in the vehicle; a data structuring portion that is configured to structure the plurality of pieces of the vehicle data that are normalized by the normalization portion into a predetermined data structure; and a data transmission portion that is configured to transmit the plurality of pieces of the vehicle data structured by the data structuring portion to the center through a communicator.

A thus configured in-vehicle system according to the present disclosure is an in-vehicle system provided with an in-vehicle device according to the present disclosure and the same effect as by the in-vehicle device according to the present disclosure can be brought about.

A description will be given to embodiments of the present disclosure with reference to the drawings.

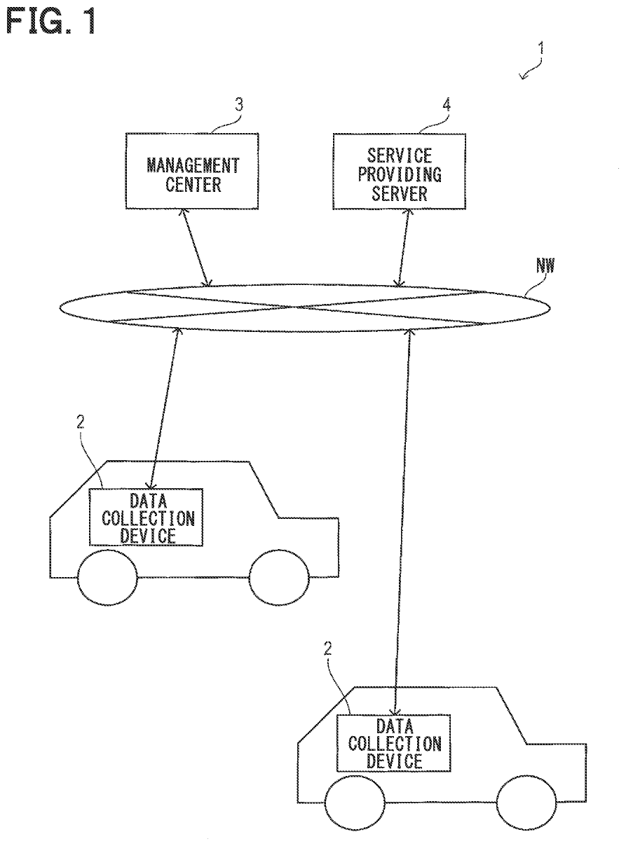

As shown in FIG. 1, a mobility IoT system 1 according to the present embodiment includes a plurality of data collection devices 2, a management center 3, and a service providing server 4. IoT is an abbreviation of Internet of Things.

The data collection device 2 is mounted in a vehicle and has a function of performing data communication with the management center 3 through a wide-area wireless communication network NW.

The management center 3 is a device that manages the mobility IoT system 1. The management center 3 has a function of performing data communication with a plurality of the data collection devices 2 and the service providing server 4 through the wide-area wireless communication network NW.

The service providing server 4 is a server installed to provide a service to manage, for example, an operation of a vehicle. The mobility IoT system 1 may be provided with a plurality of service providing servers different from each other in the contents of services. These service providing servers 4 may be configured on-premises, may be configured in cloud, or may be configured as the physically same server as the management center 3.

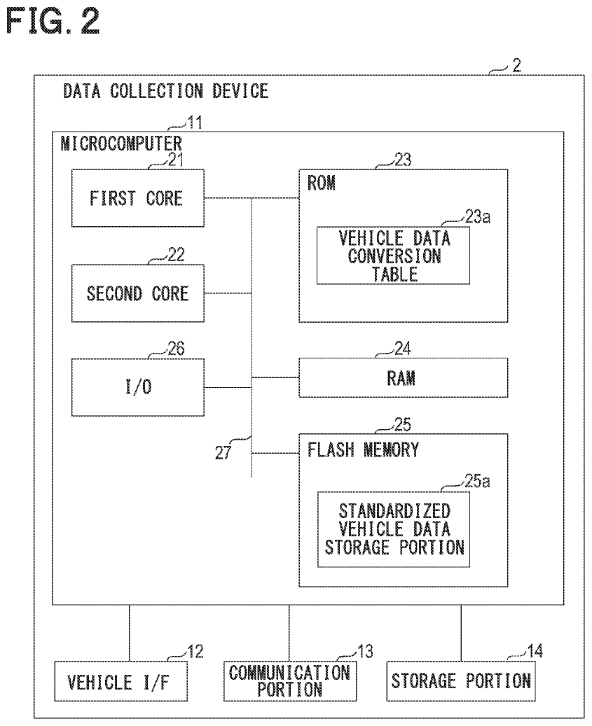

As shown in FIG. 2, the data collection device 2 includes a microcomputer 11, a vehicle interface (hereafter, referred to as vehicle I/F) 12, a communication portion 13, and a storage portion 14.

The microcomputer 11 includes a first core 21, a second core 22, ROM 23, RAM 24, a flash memory 25, an input/output portion 26, and a bus 27.

The various functions of the microcomputer 11 are conducted by the first core 21 and the second core 22 executing programs stored in a non-transitional tangible recording medium. In this example, the ROM 23 is equivalent to the non-transitional tangible recording medium holding programs. As a result of this execution of a program, a method corresponding to the program is performed.

A part or all of the functions conducted by the first core 21 and the second core 22 may be configured by hardware using one or more ICs or the like.

The flash memory 25 is a data rewritable nonvolatile memory. The flash memory 25 includes a standardized vehicle data storage portion 25a for storing standardized vehicle data, described later.

The input/output portion 26 is a circuit for causing data input/output between the outside of the microcomputer 11 and the first core 21 and second core 22.

The bus 27 connects the first core 21, second core 22, ROM 23, RAM 24, flash memory 25, and input/output portion 26 in such a manner that data can be inputted and outputted therebetween.

The vehicle I/F 12 is an input/output circuit for causing signal input/output between an electronic control unit and a sensor or the like mounted in a vehicle.

The vehicle I/F 12 includes a supply voltage input port, a general-purpose input/output port, a CAN communication port, an Ethernet communication port, and the like.

The supply voltage input port includes a +B voltage port to which a +B voltage is inputted and an IG voltage port to which an IG voltage is inputted. The vehicle I/F 12 includes a protective circuit having a DCDC converter and a Zener diode. As a result, the supply voltage input port is so configured to be capable of accommodating both an input of a 12V vehicle voltage and an input of a 48V vehicle voltage.

The CAN communication port is a port for sending and receiving data according to a CAN communication protocol. The Ethernet communication port is a port for sending and receiving data according to an Ethernet communication protocol. CAN is an abbreviation of Controller Area Network. CAN is a registered trademark. Ethernet is a registered trademark.

The CAN communication port and the Ethernet communication port have other electronic control units mounted in the vehicle connected thereto. As a result, the data collection device 2 is capable of sending and receiving a communication frame to and from other electronic control units.

The communication portion 13 performs data communication with the management center 3 through a wide-area wireless communication network NW.

The storage portion 14 is a storage device for storing varied data.

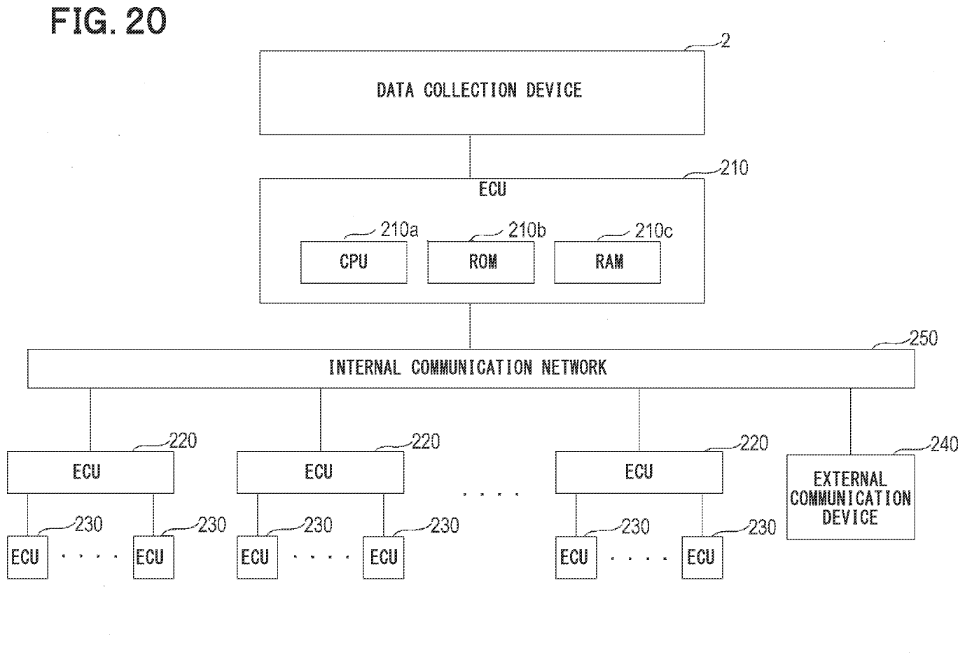

As shown in FIG. 20, the vehicle is mounted with one ECU 210, a plurality of ECUs 220, a plurality of ECUs 230, an external communication device 240, and an internal communication network 250. ECU is an abbreviation of Electronic Control Unit.

The ECU 210 implements control coordinated throughout the vehicle by supervising the ECUs 220.

The ECU 220 is provided for each domain classified according to functions within the vehicle and mainly exercises control of the ECUs 230 existing in the domains. Each ECU 220 is connected with ECU 230 under the control thereof through an individually provided respective lower-layer network (for example, CAN). The ECU 220 has a function of unitarily managing access authority to the ECU 230 under the control thereof and the like and performing user authorization and the like. Examples of the domains include power train, body, chassis, cockpit, and the like.

ECUs 230 connected to ECU 220 belonging to the domain of power train include, for example, ECU 230 controlling an engine, ECU 230 controlling a motor, ECU 230 controlling a battery, and the like.

ECUs 230 connected to ECU 220 belonging to the domain of body include, for example, ECU 230 controlling an air conditioner, ECU 230 controlling a door, and the like.

ECUs 230 connected to ECU 220 belonging to the domain of chassis include, for example, ECU 230 controlling a braking, ECU 230 controlling steering, and the like.

ECUs 230 connected to ECU 220 belonging to the domain of cockpit include, for example, ECU 230 that controls displays of a meter and a navigation, ECU 230 that controls an input device operated by an occupant of the vehicle, and the like.

The external communication device 240 performs data communication with a communication device (for example, cloud server) external to the vehicle through a wide-area wireless communication network NW.

The internal communication network 250 includes the CAN FD and the Ethernet. CAN FD is an abbreviation of CAN with Flexible Data Rate. The CAN FD connects the ECU 210 and each ECU 220 and external communication device 240 through a bus. The Ethernet individually connects the ECU 210 and each ECU 220 and external communication device 240.

The ECU 210 is an electronic control unit configured based on a microcomputer having CPU 210a, ROM 210b, RAM 210c, and the like. The various functions of the microcomputer are conducted by the CPU 210a executing programs stored in a non-transitional tangible recording medium. In this example, the ROM 210b is equivalent to the non-transitional tangible recording medium holding programs. As a result of this execution of a program, a method corresponding to the program is performed. A part or all of the functions conducted by the CPU 210a may be configured by hardware using one or more ICs or the like. The number of microcomputers constituting the ECU 210 may be one or more.

Like the ECU 210, each of the ECUs 220, ECUs 230, and external communication device 240 is an electronic control unit configured based on a microcomputer having CPU, ROM, RAM, and the like. The number of microcomputers constituting the ECUs 220, ECUs 230, and external communication device 240 may be one or more. The ECU 220 is ECU that supervises one or more ECUs 230 and the ECU 210 is ECU that supervises one or more ECUs 220 or supervises the ECUs 220 and 230 of the entire vehicle including the external communication device 240.

The data collection device 2 is so connected to the ECU 210 as to be capable of performing data communication with the ECU 210. That is, the data collection device 2 receives information of the ECUs 210, 220, 230 through the ECU 210. In addition, the data collection device 2 sends a request related to vehicle control to the ECU 210 or to ECUs 220, 230 through the ECU 210.

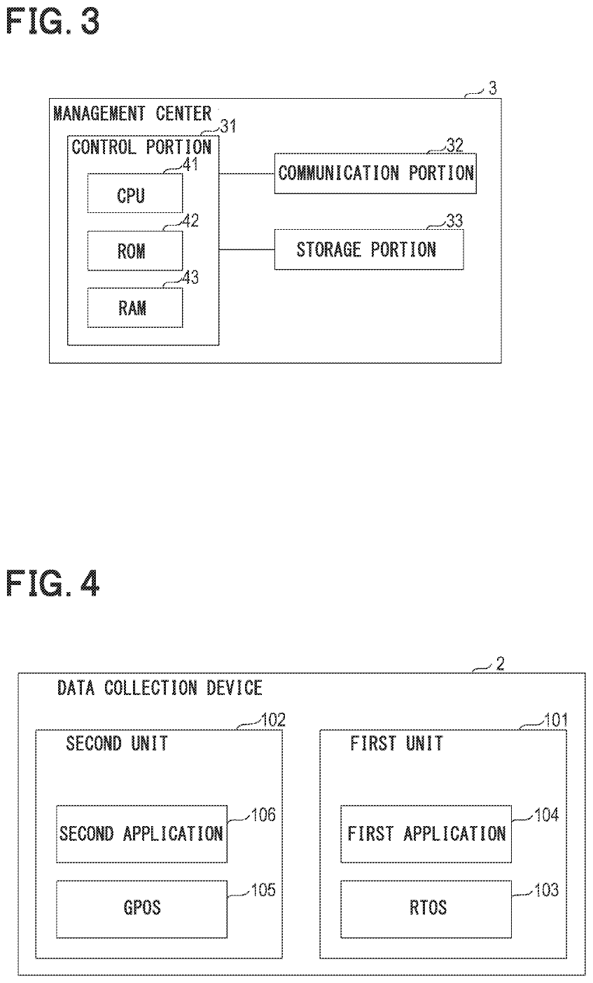

As shown in FIG. 3, the management center 3 includes a control portion 31, the communication portion 32, and a storage portion 33.

The control portion 31 is an electronic control unit configured based on a microcomputer having CPU 41, ROM 42, RAM 43, and the like. The various functions of the microcomputer are conducted by the CPU 41 executing programs stored in a non-transitional tangible recording medium. In this example, the ROM 42 is equivalent to the non-transitional tangible recording medium holding programs. As a result of this execution of a program, a method corresponding to the program is performed. A part or all of the functions conducted by the CPU 41 may be configured by hardware using one or more ICs or the like. The number of microcomputers constituting the control portion 31 may be one or more.

The communication portion 32 performs data communication with a plurality of data collection devices 2 and the service providing server 4 through a wide-area wireless communication network NW.

The storage portion 33 is a storage device for storing varied data.

As shown in FIG. 4, the data collection device 2 includes a first unit 101 as a functional block implemented by the first core 21 executing a program stored in the ROM 23. The data collection device 2 includes a second unit 102 as a functional block implemented by the second core 22 executing a program stored in the ROM 23.

The first unit 101 includes a real time operating system (hereafter, referred to as RTOS) 103 and a first application 104.

The first application 104 performs varied processing to control the vehicle. To perform varied processing to control the vehicle, the first application 104 is so configured as to be capable of accessing a standardized vehicle data storage portion 25a of the flash memory 25 to reference to standardized vehicle data.

The RTOS 103 manages the first application 104 so that a real-time property of processing by the first application 104 can be ensured.

The second unit 102 includes a general-purpose operating system (hereafter, referred to as GPOS) 105 and a second application 106.

The second application 106 performs processing related to services provided by a service providing server 4. To perform processing related to services, the second application 106 is so configured as to be capable of accessing the standardized vehicle data storage portion 25a of the flash memory 25 to reference to standardized vehicle data.

The GPOS 105 is basic software installed in the data collection device 2 to run various applications and manages the second application 106.

The data collection device 2 may cause a single-core microcomputer to implement operations under the RTOS 103 and operations under the GPOS 105 using a hypervisor.

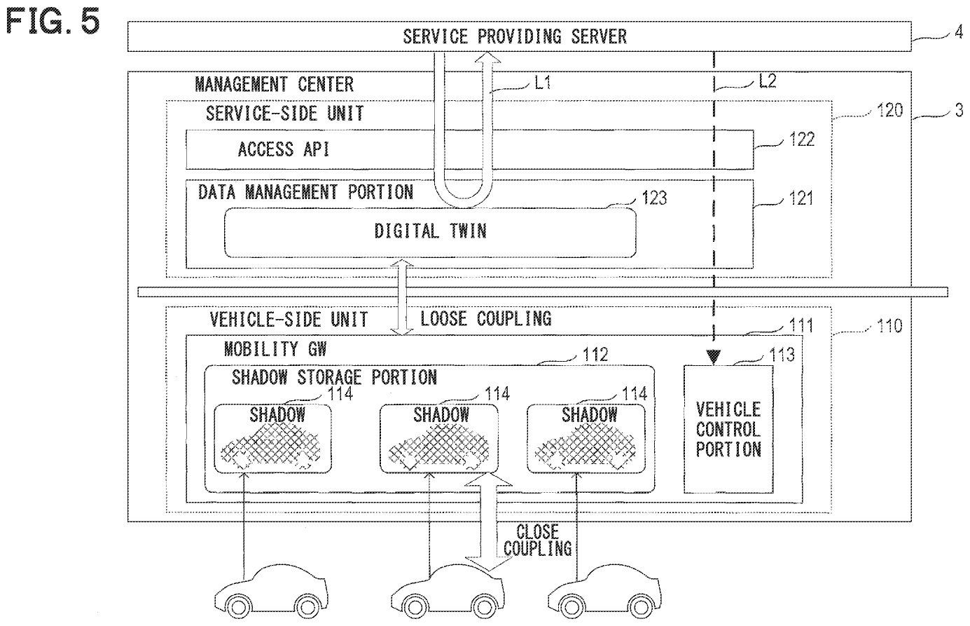

As illustrated in FIG. 5, the management center 3 includes a vehicle-side unit 110 and a service-side unit 120 as functional blocks implemented by the CPU 41 executing a program stored in the ROM 42. The side closer to access to the vehicle is taken as the vehicle-side unit 110 and the side closer to access from the service providing server 4 is taken as the service-side unit 120 and the functional block is divided into two; and these two functional blocks are configured in a loosely coupled manner.

A technique for implementing these elements constituting the management center 3 need not be software and some or all of the elements may be implemented using one or more pieces of hardware. For example, when the above functions are implemented by an electronic circuit as hardware, the electronic circuit may be implemented by a digital circuit, an analog circuit including a large number of logical circuits, or a combination thereof.

The vehicle-side unit 110 manages access to the vehicle and data received from the vehicle. The vehicle-side unit 110 includes a mobility gateway (hereafter, referred to as mobility GW) 111. The mobility GW 111 has also a function of managing data received from the vehicle aside from a function of relaying a vehicle access request to the vehicle.

The mobility GW 111 includes a shadow storage portion 112 and a vehicle control portion 113. The shadow storage portion 112 stores shadow 114 holding vehicle data for each vehicle mounted with the data collection device 2. Shadows 114 indicates a vehicle data group of some vehicle. The vehicle control portion 113 has a function of controlling a vehicle mounted with the data collection device 2 based on an instruction from the service providing server 4.

The service-side unit 120 accepts a request from the service providing server 4 and provides vehicle data. The service-side unit 120 includes a data management portion 121 and an access API 122. API is an abbreviation of Application Programming Interface.

The data management portion 121 has a function of managing a digital twin 123 that is a virtual space for providing vehicle access independent of variation in a connection state of the vehicle. The data management portion 121 manages data required for access to vehicle data managed at the vehicle-side unit 110.

The access API 122 is a standard interface for the service providing server 4 to access the mobility GW 111 and the data management portion 121. The access API 122 provides the service providing server 4 with API for access to the vehicle and acquisition of vehicle data.

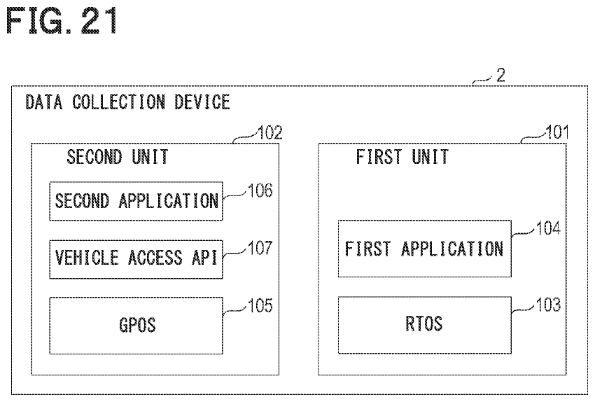

As shown in FIG. 21, the second unit 102 further includes a vehicle access API 107.

The vehicle access API 107 is a standard interface for the second application 106 to access the standardized vehicle data storage portion 25a. The vehicle access API 107 provides the second application 106 with API for access to the vehicle and acquisition of vehicle data.

That is, when a service provider performs processing related to a predetermined service by the second application 106 installed in the vehicle, the second application 106 references to standardized vehicle data stored in the standardized vehicle data storage portion 25a of the vehicle. The second application 106 acquires standardized vehicle data of the relevant vehicle through the vehicle access API 107.

Meanwhile, for the service provider to provide a predetermined service to a plurality of target vehicles by a program installed in the service providing server 4, the service provider references to standardized vehicle data stored in the data management portion 121 through the access API 122 to acquire standardized vehicle data of the target vehicles.

As mentioned above, by generating standardized vehicle data in the vehicle, not at the management center 3, even a service provider whose is not knowledgeable about the vehicle can produce and provide the second application 106.

A description will be given to processing performed by the vehicle I/F 12.

When receiving a communication frame, the vehicle I/F 12 determines a communication protocol of the communication frame based on a communication port at which the communication frame was received. Specifically, for example, when a communication frame is received at the CAN communication port, the vehicle I/F 12 determines a communication protocol of the received communication frame to be the CAN communication protocol. When a communication frame is received at the Ethernet communication port for example, the vehicle I/F 12 determines a communication protocol of the received communication frame to be the Ethernet communication protocol.

The vehicle I/F 12 determines whether the communication frame is required or not based on the identification information of the communication frame; and when it is determined that the communication frame is required, the vehicle I/F 12 outputs the received communication frame to the first unit 101.

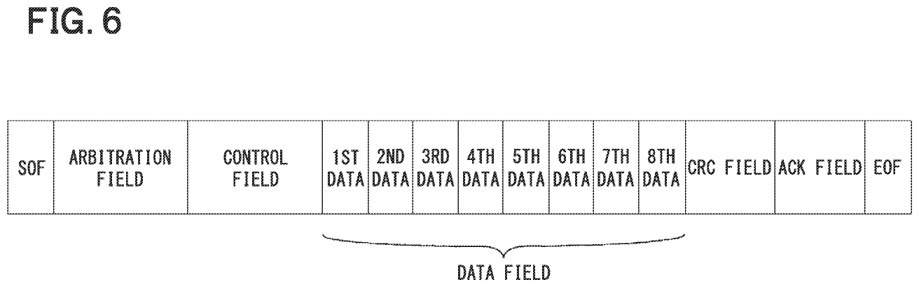

As shown in FIG. 6, the CAN frame is comprised of start of frame, arbitration field, control field, data field, CRC field, ACK field, and end of frame. The arbitration field is comprised of an 11-bit or 29-bit identifier (that is, ID) and a 1-bit RTR bit.

The 11-bit identifier used in CAN communication is designated as CAN ID. The CAN ID is preset based on the contents of data contained in a CAN frame, the transmission source of the CAN frame, the transmission destination of the CAN frame, and the like.

The data field is a payload comprised of first data, second data, third data, fourth data, fifth data, sixth data, seventh data, and eighth data, each of which is of 8 bits (that is, 1 byte). Hereafter, each of the first to eighth data in the data field is also referred to as CAN data.

For this reason, when a CAN frame is received, the vehicle I/F 12 determines whether the received CAN frame is required or not based on CAN ID. When the received CAN frame is not required, the vehicle I/F discards the CAN frame; and when the received CAN frame is required, the vehicle I/F performs the processing described later. Also, for other communication frames than the CAN frame, similar filtering processing may be performed.

A description will be given to processing performed by the first unit 101.

When acquiring a communication frame outputted from the vehicle I/F 12, the first unit 101 extracts identification information and a payload from the communication frame, generates standard format data comprised of the identification information and the payload, and stores the generated standard format data in the flash memory 25. For example, when a CAN frame is acquired, the first unit 101 generates standard format data comprised of CAN ID and first to eighth data. Identification information (second identification information) contained in standard format data need not be identical with identification information (first identification information) extracted from communication frame. For example, the first identification information may be used to generate unique second identification information or the identification information and first identification information in a communication protocol may be used and converted to generate second identification information.

When standard format data containing the same identification information as generated standard format data has been already stored in the flash memory 25, the first unit 101 overwrites the standard format data and stores the overwritten standard format data to update the standard format data. That is, with respect to identical identification information, the latest standard forma data is stored.

A description will be given to a procedure for data standardization processing performed by the second unit 102. The data standardization processing is processing repeatedly performed when the microcomputer 11 is in operation.

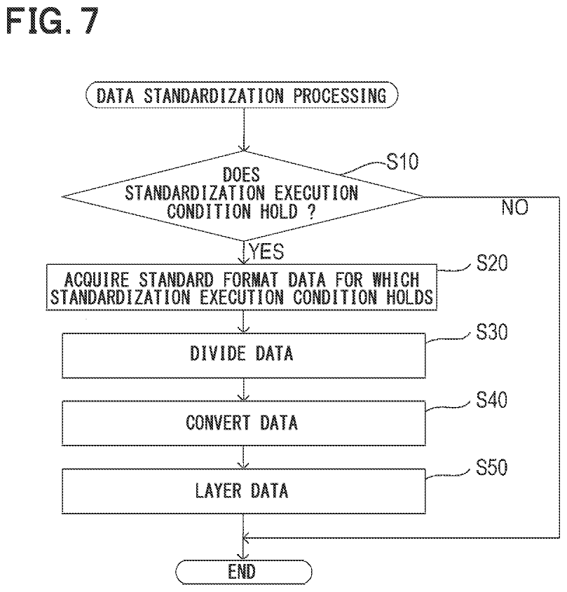

When data standardization processing is performed, as shown in FIG. 7, first, at S10, the second core 22 determines whether a preset standardization execution condition has held or not (i.e., is met or not).

The standardization execution condition is that at least any one of the first high frequency standardization condition, second high frequency standardization condition, third high frequency standardization condition, first low frequency standardization condition, second low frequency standardization condition, event standardization condition, and invariant standardization condition described later holds.

The first high frequency standardization condition is that a preset first high frequency standardization period (in the present embodiment, for example, 500 ms) should have passed.

The second high frequency standardization condition is that a preset second high frequency standardization period (in the present embodiment, for example, 2 s) should have passed.

The third high frequency standardization condition is that a preset third high frequency standardization period (in the present embodiment, for example, 4 s) should have passed.

The first low frequency standardization condition is that a preset first low frequency standardization period (in the present embodiment, for example, 30 s) should have passed.

The second low frequency standardization condition is that a preset second low frequency standardization period (in the present embodiment, for example, 300 s) should have passed.

The event standardization condition is that a preset event standardization period (in the present embodiment, for example, 12 hours) should have passed.

The invariant standardization condition is that the processing of S10 at this time should be the first processing of S10 after the microcomputer 11 is started.

When the standardization execution condition is met, the second core 22 terminates the data standardization processing. Meanwhile, when the standardization execution condition is met, at S20, the second core 22 acquires, from the flash memory 25, standard format data corresponding to the established standardization condition among the seven standardization conditions constituting the standardization execution conditions. For example, when the second high frequency standardization condition is met, at S20, the second core 22 acquires standard format data corresponding to the second high frequency standardization condition.

At S30, subsequently, the second core 22 divides data contained in the standard format data. For example, since standard format data generated from a CAN frame is comprised of CAN ID and first to eighth data, the second core 22 divides the first to eighth data by byte and extracts eight pieces of CAN data.

At S40, subsequently, the second core 22 references to a vehicle data conversion table 23a stored in the ROM 23 and converts each piece of extracted data divided at S30 into a control label and vehicle data. The control label is identification information indicating a type of the relevant vehicle data.

The vehicle data conversion table 23a contains normalization information and meaning-giving information.

The normalization information is information for normalizing extracted data so that an identical physical quantity takes an identical value regardless of car model or vehicle manufacturing company.

The meaning-giving information is information (for example, arithmetic expression, conversion table) for converting normalized vehicle data into significant vehicle data. Vehicle data before normalization may be used. Meaning-giving includes newly generating information that does not exist in the payload of a communication frame using an arithmetic expression or the like.

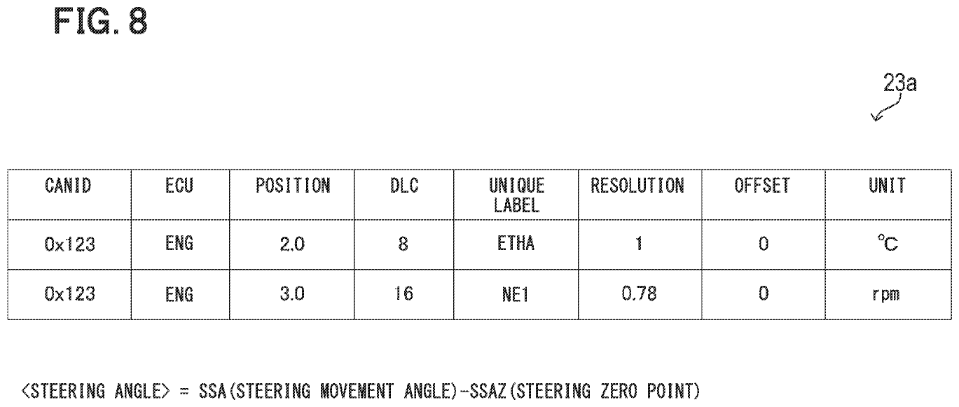

As shown in FIG. 8, the normalization information in the vehicle data conversion table 23a includes, as entries, for example, “CAN ID,” “ECU,” “position,” “DLC,” “unique label,” “resolution,” “offset,” and “unit.”

“ECU” is identification information indicating ECU that is the transmission source of a CAN frame. For example, “ENG” indicates an engine ECU.

“Position” is information indicating a position (for example, bit position) of CAN data in a data field. “DLC” is information indicating a data length. DLC is an abbreviation of Data Length Code. That is, data equivalent to “DLC” bits from “position” in a data field is taken out.

“Unique label” is information indicating a control label. For example, “ETHA” denotes an intake air temperature and “NE1” denotes an engine speed. “Resolution” is information indicating a numeric value per bit. “Offset” indicates an offset amount of a numeric value of the relevant data. “Unit” indicates the data unit.

Therefore, data corresponding to “unique label” is extracted from standard format data by “CAN ID,” “ECU,” “position,” “DLC,” and “unique label.” Further, extracted data is converted into vehicle data represented by “resolution,” “offset,” and “unit.”

The meaning-giving information” in the vehicle data conversion table 23a is, for example, a conversion formula for conversion into “steering angle” by subtracting “steering zero point” whose control label is “SSAZ” from “steering moving angle” whose control label is “SSA” as shown in FIG. 8. As a result, vehicle data indicating “steering moving angle” and vehicle data indicating “steering zero point” are converted into vehicle data representing “steering angle” meaning “amount of steering from reference position.” “Unique label,” “unit,” and the like are given to the vehicle data newly generated by meaning-giving.

The vehicle data conversion table 23a is provided also for data of “shift position” that is a predetermined control label. Data of shift positions is respectively converted into data representing “P range,” “N range,” “D range,” and “R range” by the vehicle data conversion table 23a.

When the processing of S40 is completed, at S50, the second core 22 layers the converted vehicle data as shown in FIG. 7 and stores the layered converted vehicle data into the flash memory 25. Specifically, the second core 22 stores the converted vehicle data in corresponding areas in the standardized vehicle data storage portion 25a provided in the flash memory 25.

The standardized vehicle data storage portion 25a holds standardized vehicle data configured by layering vehicle data.

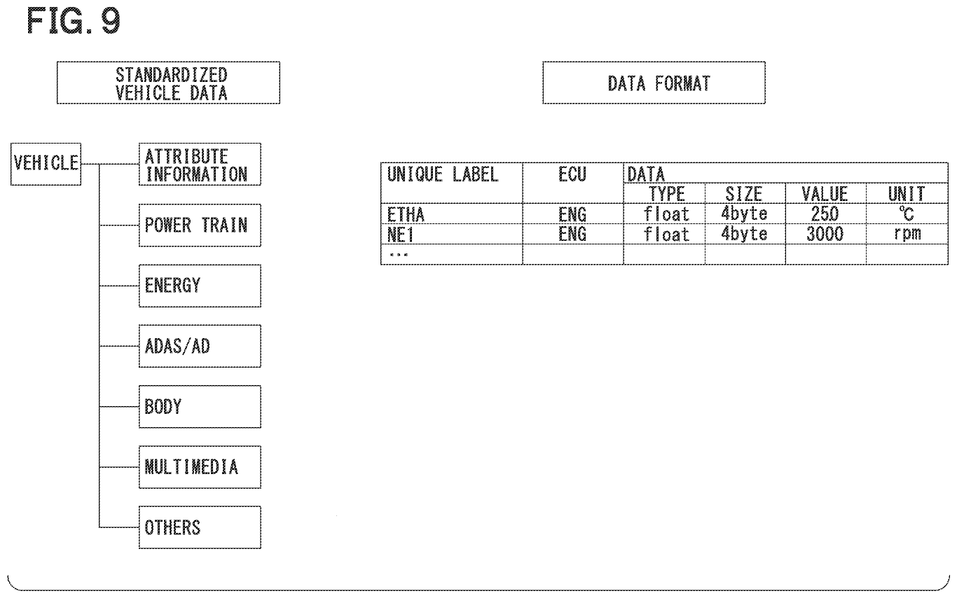

The standardized vehicle data is generated for each vehicle (that is, for each data collection device 2) and has a plurality of layered structures. In the standardized vehicle data, one or more entries are set for each of the layers. As shown in FIG. 9, for example, the standardized vehicle data includes, as entries set for the first layer in the highest order, “attribute information,” “power train,” “energy,” “ADAS/AD,” “body,” “multimedia,” and “others.” ADAS is an abbreviation of Advanced Driver Assistance System. AD is an abbreviation of Autonomous Driving. The “attribute information,” “power train,” “energy,” and the like correspond to categories.

Each vehicle data includes, as entries, “unique label,” “ECU,” “data type,” “data size,” “data value,” and “data unit.” “Unique label” and “ECU” are as described above. “Data type,” “data size,” and “data unit” respectively indicate a type, a size, and a unit related to a numeric value indicated by “data value.”

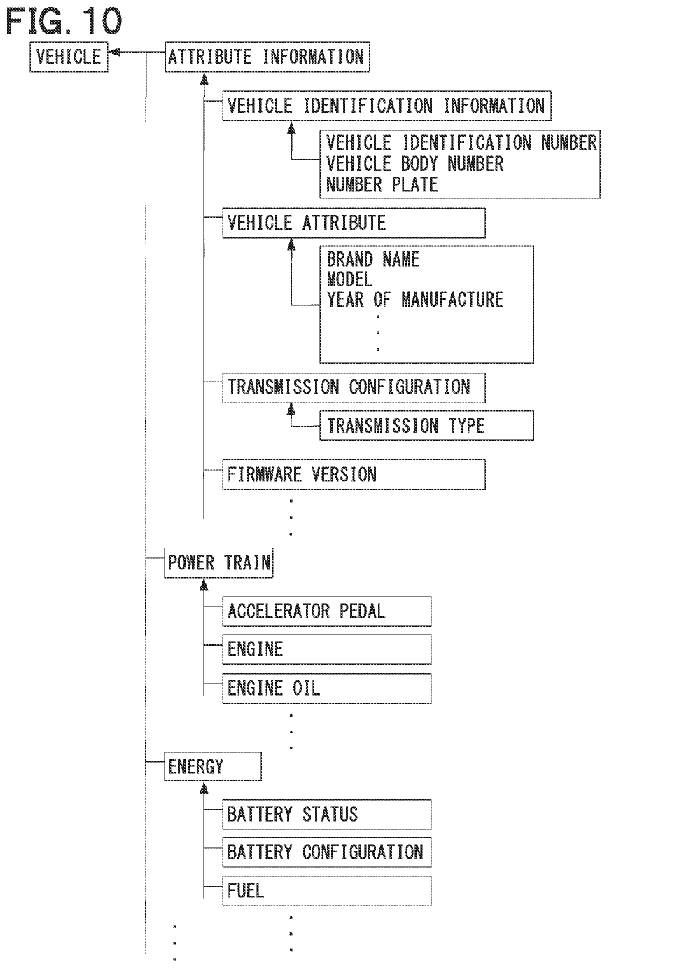

As shown in FIG. 10, in addition to the first layer, the standardized vehicle data includes at least a second layer and a third layer. The second layer is a layer immediately below the first layer and the third layer is a layer immediately below the second layer. The standardized vehicle data is an entry set in the above-mentioned normalization and meaning-giving processing. The standardized vehicle data has a data structure as a layered structure.

For example, “attribute information” as an entry in the first layer includes, as entries in the second layer, “vehicle identification information,” “vehicle attribute,” “transmission configuration,” “firmware version,” and the like. “Vehicle identification information” is a category name indicating information that enables the vehicle to be uniquely identified. “Vehicle attribute” is a category name indicating a type of the vehicle. “Transmission information” is a category name indicating information related to a transmission. “Firmware version” is a category name indicating information related to a firmware version.

“Power train” as an entry in the first layer is a category name indicating power train information and includes “accelerator pedal,” “engine,” “engine oil,” and the like as entries in the second layer. “Accelerator pedal” includes one or more vehicle data including a state, an opening and the like of an accelerator pedal. “Engine” includes one or more pieces of respective vehicle data including a state, a number of revolutions, and the like of an engine. These entries in the second layer are also equivalent to categories. This is also the case with the other entries in the first layer.

“Energy” as an entry in the first layer is a category name indicating energy information and includes “battery state,” “battery configuration,” “fuel,” and the like as entries in the second layer.

The “vehicle identification information” as an entry in the second layer includes “vehicle identification number,” “vehicle body number,” and “number plate” as entries in the third layer. These entries in the third layer includes one or more pieces of respective vehicle data (also, referred to as item).

The “vehicle attribute” as an entry in the second layer includes “brand name,” “model,” “year of manufacture,” and the like as entries in the third layer.

The “transmission configuration” as an entry in the second layer includes “transmission type” as an entry in the third layer. These entries in the third layer are also referred to as items and are the minimum unit of a data structure.

For example, when the control label of converted vehicle data is “vehicle identification information,” the second core 22 places the converted data in a storage area in the standardized vehicle data storage portion 25a whose first layer is “attribute information,” second layer is “vehicle identification information,” and third layer is “vehicle identification number.”

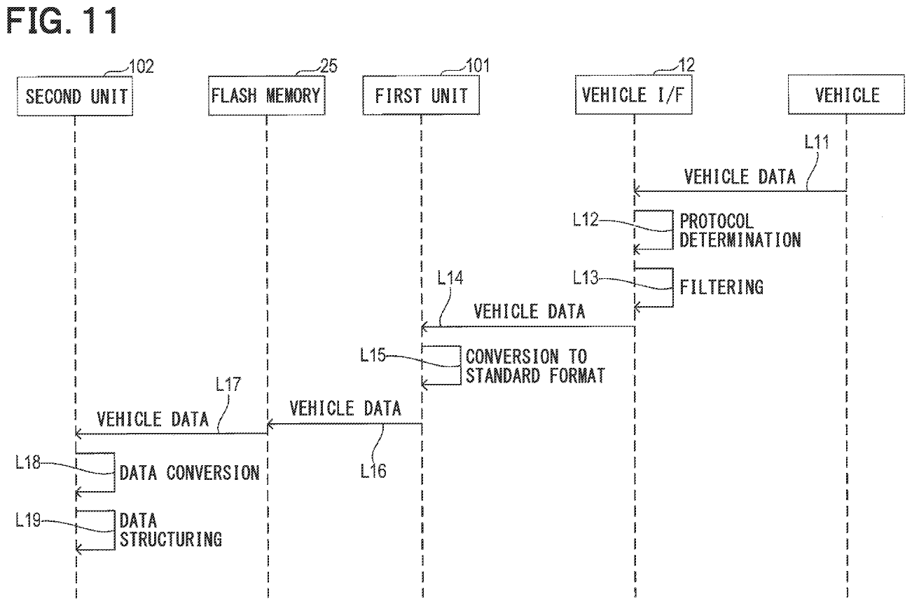

A description will be given to a procedure for the data collection device 2 to generate standardized vehicle data with reference to the sequence diagram shown in FIG. 11.

When the vehicle I/F 12 acquires vehicle data from the vehicle, as indicated by the arrow L11, the vehicle I/F 12 makes communication protocol determination as indicated by the arrow L12. Further, the vehicle I/F 12 filters unnecessary vehicle data as indicated by the arrow L13 and outputs necessary vehicle data to the first unit 101 as indicated by the arrow L14.

When acquiring the vehicle data from the vehicle I/F 12, the first unit 101 converts the vehicle data into the standard format as indicated by the arrow L15 and stores the vehicle data converted into the standard format in the flash memory 25 as indicated by the arrow L16.

When acquiring the vehicle data converted into the standard format from the flash memory 25 as indicated by the arrow L17, the second unit 102 converts the acquired vehicle data as indicated by the arrow L18. Further, the second unit 102 structures the converted data to generate standardized vehicle data as indicated by the arrow L19.

A description will be given to a procedure for data transmission processing performed by the data collection device 2. The data transmission processing is processing repeatedly performed when the microcomputer 11 is in operation.

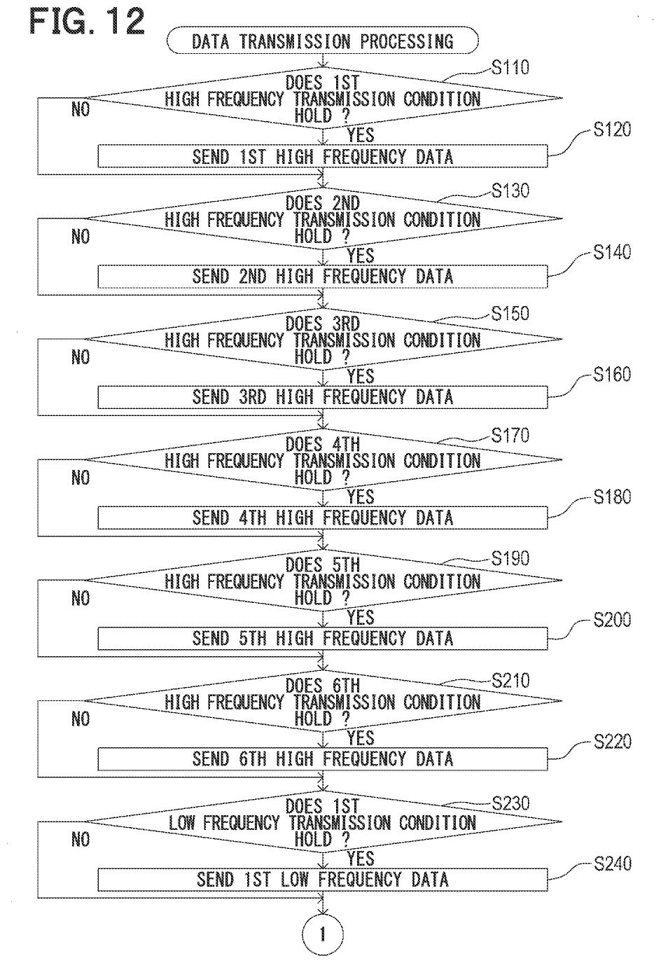

When data transmission processing is performed, as shown in FIG. 12, first, at S110, the second core 22 determines whether a preset first high frequency transmission condition has held or not (i.e., is met or not). The first high frequency transmission condition is that mod{tx/(T×2)} should be 0, where tx is the current time; and T is a transmission interval set value (in the present embodiment, for example, 500 ms).

When the first high frequency transmission condition is not met, the second core 22 proceeds to S130. Meanwhile, when the first high frequency transmission condition is met, at S120, the second core 22 extracts vehicle data set as first high frequency data among vehicle data constituting standardized vehicle data from the standardized vehicle data storage portion 25a, sends the vehicle data to the management center 3, and proceeds to S130.

Aside from the above-mentioned first high frequency data, vehicle data constituting standardized vehicle data is set to any of the second high frequency data, third high frequency data, fourth high frequency data, fifth high frequency data, sixth high frequency data, first low frequency data, second low frequency data, third low frequency data, fourth low frequency data, event data, and invariant data described later. A transmission frequency setting table that specifies to which of the first, second, third, fourth, fifth, and sixth high frequency data, first, second, third, and fourth low frequency data, event data, and invariant data each vehicle data is set is stored in the flash memory 25 in advance.

After proceeding to S130, the second core 22 determines whether a preset second high frequency transmission condition holds or not (i.e., is met or not). The second high frequency transmission condition is that mod{(tx+T)/(T×2)} should be 0.

When the second high frequency transmission condition is not met, the second core 22 proceeds to S150. Meanwhile, when the second high frequency transmission condition is met, at S140, the second core 22 extracts vehicle data set as second high frequency data among vehicle data constituting standardized vehicle data from the standardized vehicle data storage portion 25a, sends the vehicle data to the management center 3, and proceeds to S150.

After proceeding to S150, the second core 22 determines whether a preset third high frequency transmission condition holds or not (i.e., is met or not). The third high frequency transmission condition is that mod{tx/(T33 8)} should be 0.

When the third high frequency transmission condition is not met, the second core 22 proceeds to S170. Meanwhile, when the third high frequency transmission condition is met, at S160, the second core 22 extracts vehicle data set as third high frequency data among vehicle data constituting standardized vehicle data from the standardized vehicle data storage portion 25a, sends the vehicle data to the management center 3, and proceeds to S170.

After proceeding to S170, the second core 22 determines whether a preset fourth high frequency transmission condition holds or not (i.e., is met or not). The fourth high frequency transmission condition is that mod{(tx+T)/(T×8)} should be 0.

When the fourth high frequency transmission condition is not met, the second core 22 proceeds to S190. Meanwhile, when the fourth high frequency transmission condition is met, at S180, the second core 22 extracts vehicle data set as fourth high frequency data among vehicle data constituting standardized vehicle data from the standardized vehicle data storage portion 25a, sends the vehicle data to the management center 3, and proceeds to S190.

After proceeding to S190, the second core 22 determines whether a preset fifth high frequency transmission condition holds or not (i.e., is met or not). The fifth high frequency transmission condition is that mod{(tx/(T×16)} should be 0.

When the fifth high frequency transmission condition is not met, the second core 22 proceeds to S210. Meanwhile, when the fifth high frequency transmission condition is met, at S200, the second core 22 extracts vehicle data set as fifth high frequency data among vehicle data constituting standardized vehicle data from the standardized vehicle data storage portion 25a, sends the vehicle data to the management center 3, and proceeds to S210.

After proceeding to S210, the second core 22 determines whether a preset sixth high frequency transmission condition holds or not (i.e., is met or not). The sixth high frequency transmission condition is that mod{(tx+T)/(T×16)} should be 0.

When the sixth high frequency transmission condition is not met, the second core 22 proceeds to S230. Meanwhile, when the sixth high frequency transmission condition is met, at S180, the second core 22 extracts vehicle data set as sixth high frequency data among vehicle data constituting standardized vehicle data from the standardized vehicle data storage portion 25a, sends the vehicle data to the management center 3, and proceeds to S230.

After proceeding to S230, the second core 22 determines whether a preset first low frequency transmission condition holds or not (i.e., is met or not). The first low frequency transmission condition is that mod{tx+/(T×120)} should be 0.

When the first low frequency transmission condition is not met, the second core 22 proceeds to S250. Meanwhile, when the first low frequency transmission condition is met, at S240, the second core 22 extracts vehicle data set as first low frequency data among vehicle data constituting standardized vehicle data from the standardized vehicle data storage portion 25a, sends the vehicle data to the management center 3, and proceeds to S250.

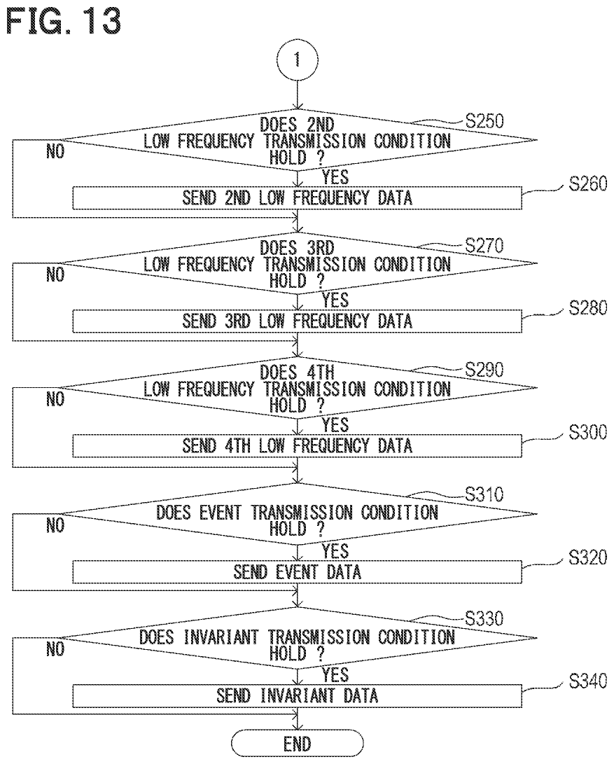

After proceeding to S250, as shown in FIG. 13, the second core 22 determines whether a preset second low frequency transmission condition holds or not (i.e., is met or not). The second low frequency transmission condition is that mod{(tx+T)/(T×120)} should be 0.

When the second low frequency transmission condition is not met, the second core 22 proceeds to S270. Meanwhile, when the second low frequency transmission condition is met, at S260, the second core 22 extracts vehicle data set as second low frequency data among vehicle data constituting standardized vehicle data from the standardized vehicle data storage portion 25a, sends the vehicle data to the management center 3, and proceeds to S270.

After proceeding to S270, the second core 22 determines whether a preset third low frequency transmission condition holds or not (i.e., is met or not). The third low frequency transmission condition is that mod{tx/(T×120)} should be 0.

When the third low frequency transmission condition is not met, the second core 22 proceeds to S290. Meanwhile, when the third low frequency transmission condition is met, at S280, the second core 22 extracts vehicle data set as third low frequency data among vehicle data constituting standardized vehicle data from the standardized vehicle data storage portion 25a, sends the vehicle data to the management center 3, and proceeds to S290.

After proceeding to S290, the second core 22 determines whether a preset fourth low frequency transmission condition holds or not (i.e., is met or not). The fourth low frequency transmission condition is that mod{(tx+T)/(T×1200)} should be 0.

When the fourth low frequency transmission condition is not met, the second core 22 proceeds to S310. Meanwhile, when the fourth low frequency transmission condition is met, at S300, the second core 22 extracts vehicle data set as fourth low frequency data among vehicle data constituting standardized vehicle data from the standardized vehicle data storage portion 25a, sends the vehicle data to the management center 3, and proceeds to S310.

After proceeding to S310, the second core 22 determines whether a preset event transmission condition holds or not (i.e., is met or not). The event transmission condition is that mod{tx/(T×172800)} should be 0.

When the event transmission condition is not met, the second core 22 proceeds to S330. Meanwhile, when the event transmission condition is met, at S320, the second core 22 extracts vehicle data set as event data among vehicle data constituting standardized vehicle data from the standardized vehicle data storage portion 25a, sends the vehicle data to the management center 3, and proceeds to S330.

After proceeding to S330, the second core 22 determines whether a preset invariant transmission condition holds or not (i.e., is met or not). The invariant transmission condition is that the processing of S330 at this time should be the first processing of S330 after the microcomputer 11 is started.

When the invariant transmission condition is not met, the second core 22 terminates the data transmission processing. Meanwhile, when the invariant transmission condition is met, at S340, the second core 22 extracts vehicle data set as invariant data from vehicle data constituting standardized vehicle data from the standardized vehicle data storage portion 25a, sends the vehicle data to the management center 3, and terminates the data transmission processing.

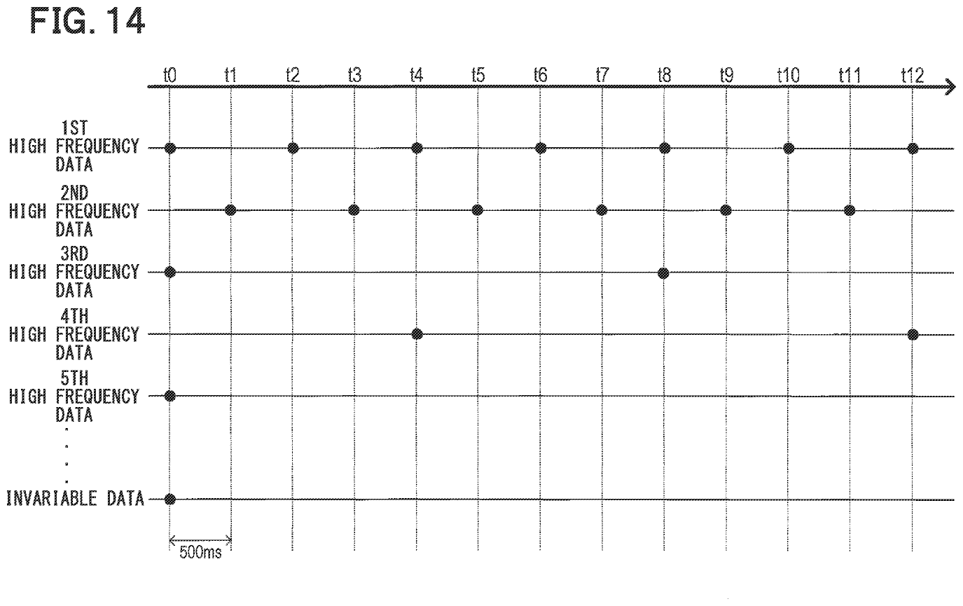

In cases where time t0 is the initial transmission timing, at time t0, first high frequency data, third high frequency data, fifth high frequency data, first low frequency data, third low frequency data, event data, and invariant data are sent as shown in FIG. 14.

First high frequency data is sent each time 1000 ms has passed after time t0. Second high frequency data is sent at time t1 when 500 ms has passed after time t0 and is thereafter sent each time 1000 ms has passed after time t1.

Third high frequency data is sent each time 4 s has passed after time t0. Fourth high frequency data is sent at time t4 when 2 s has passed after time t0 and is thereafter sent each time 4 s has passed after time t4.

Fifth high frequency data is sent each time 8 s has passed after time t0. Sixth high frequency data is sent when 4 s has passed after time t0 and is thereafter sent each time 8 s has passed.

First low frequency data is sent each time 1 minute has passed after time t0. Second low frequency data is sent when 30 s has passed after time t0 and is thereafter sent each time 1 minute has passed.

Third low frequency data is sent each time 10 minutes has passed after time t0. Fourth low frequency data is sent when 5 minutes has passed after time t0 and is thereafter sent each time 10 minutes has passed.

Event data is sent each time 12 hours has passed after time t0.

The second application 106 of the second unit 102 conducts an analysis. In cases where the second application 106 is, for example, a driving diagnosis application, the second application 106 detects, “abrupt steering,” “heavy braking,” and “sudden acceleration,” outputs a result of an analysis, such as “hurried driving” and “relaxed driving,” or performs other like operations. In cases where the second application 106 is, for example, a parking monitoring application, the second application 106 detects “suspicious person found” and “intrusion into vehicle.”

The second application 106 sends information (hereafter, referred to as analysis information) indicating the above detection result or analysis result to the management center 3. The second application 106 sends such an “event” as the above-mentioned “abrupt steering” and “suspicious person found” to the management center 3 at the time of detection. The second application 106 sends such a “state” as the above-mentioned “hurried driving” to the management center at the time of determination of the “state,” periodically sends the “state” to the management center 3, or performs other like operations.

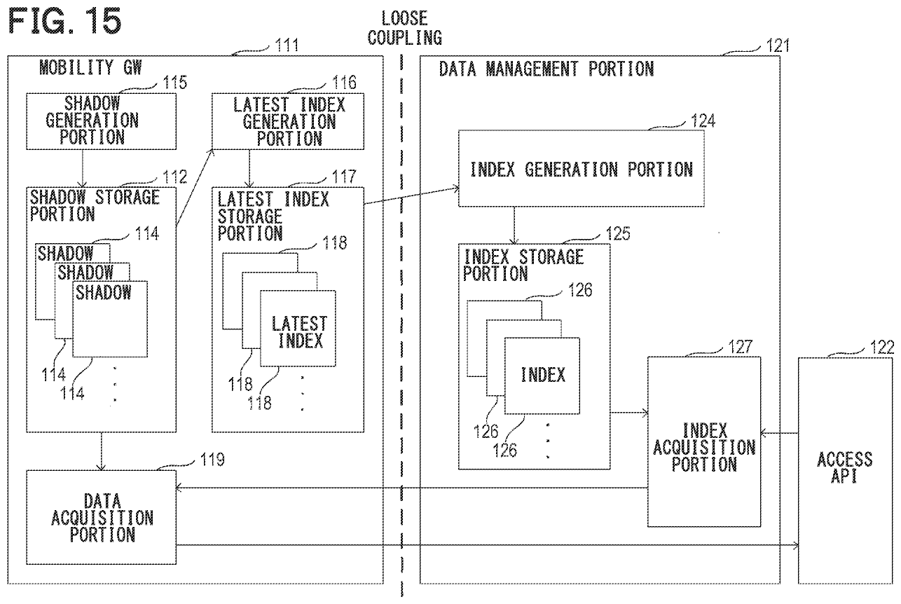

As shown in FIG. 15, the mobility GW 111 includes a shadow generation portion 115, a latest index generation portion 116 and a latest index storage portion 117.

Each time vehicle data or analysis information is sent from the data collection device 2, the shadow generation portion 115 overwrites the relevant region of structured standardized vehicle data with the data or information to update the standardized vehicle data.

In cases where analysis information related to the above-mentioned “state” has not been sent when standardized vehicle data is updated, the shadow generation portion 115 copies a previous value to the relevant region corresponding to this “state.” In cases where analysis information related to the above-mentioned “event” has not been sent when standardized vehicle data is updated, the shadow generation portion 115 keeps the relevant region corresponding to this “event” in “blank (no event).”

The shadow generation portion 115 generates a new shadow 114 using updated standardized vehicle data. The shadow generation portion 115 stores the generated shadow 114 in a shadow storage portion 112. As a result, a plurality of shadows 114 different in generation time from vehicle to vehicle are stored in the shadow storage portion 112. One shadow 114 is a vehicle data group of some vehicle at predetermined time and includes a vehicle data group expressed by a standardized data structure shown in FIG. 10. Timing with which the shadow generation portion 115 receives structured standardized vehicle data through a communication portion 32 is different from vehicle to vehicle; however, a new shadow may be generated with identical timing with respect to all the vehicles. The shadow generation portion 115 may generate a new shadow in a constant cycle with respect to all the vehicles. Past shadows 114 are accumulated in the shadow storage portion 112 with respect to each vehicle. Shadows 114 that have passed a certain period of time may be sequentially deleted.

The shadow generation portion 115 receives standardized vehicle data formed in a layered structure from the data collection device 2. The shadow generation portion 115 may be so configured as to receive data in a layered structure as a part of standardized vehicle data. When generating a new shadow 114 using updated standardized vehicle data, the shadow generation portion 115 may give such arbitrary information as a serial number before storing the new shadow in the shadow storage portion 112.

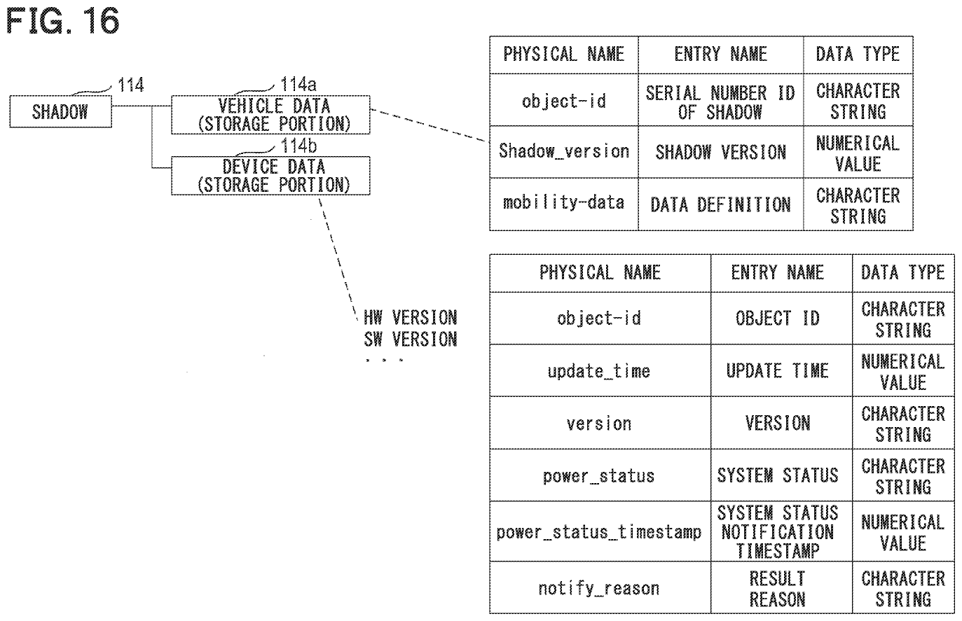

As shown in FIG. 16, the shadow 114 includes a vehicle data storage portion 114a and a device data storage portion 114b.

The vehicle data storage portion 114a holds “object-id,” “Shadow_version,” and “mobility-data” as data related to a vehicle mounted with the data collection device 2.

“Object-id” is a number for identifying a vehicle. “Object-id” is given each time a vehicle to be managed is registered at the management center 3.

“Shadow_version” is a numeric value indicating a version of a shadow 114 and each time a shadow 114 is generated, a timestamp indicating the time of the generation is set.

“Mobility-data” is the above-mentioned standardized vehicle data.

The device data storage portion 114b holds “object-id,” “update_time,” “version,” “power_status,” “power_status_timestamp,” and “notify_reason” as data related to hardware and software installed in the data collection device 2. Such data as “version,” “power_status,” and the like is sent from the data collection device 2 separately from standardized vehicle data when some change occurs.

“Object-id” is a character string identifying a vehicle mounted with the data collection device 2 and functions as a partition key.

“Update_time” is a numeric value indicating update time.

“Version” is a character string indicating a version of hardware and software of the data collection device 2.

“Power_status” is a character string indicating a system status (on, off, or the like) of the data collection device 2.

“Power_status_timestamp” is a numeric value indicating the time of notification of a system status.”

“Notify_reason” is a character string indicating a reason for notification.

As mentioned above, the shadow 114 contains information of the data collection device 2 in addition to vehicle data group. The device data storage portion 114b may separately store information of the data collection device 2 in ROM 42 without including the information in a shadow 114. With respect to information of the data collection device 2, the device data storage portion 114b may store only latest data in ROM 42 instead of accumulating past data for each timestamp.

A latest index generation portion 116 acquires a latest shadow 114 for each vehicle from the shadow storage portion 112 and generates a latest index 118 (also, referred to as first index” using the acquired shadow 114. The latest index generation portion 116 stores the generated latest index 118 in the latest index storage portion 117. One latest index 118 is stored in the latest index storage portion 117 for each vehicle. The index is parameter information used as a key to retrieve a shadow 114 from the shadow storage portion 112. The latest index generation portion 116 generates a latest index 118 by using vehicle data acquired from the data collection device 2, by generating data for itself, or performing other like operations.

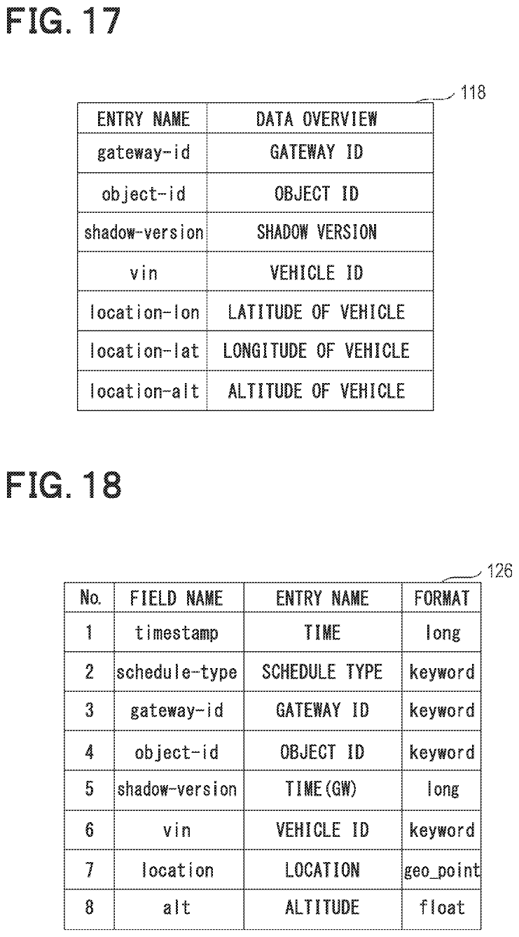

As shown in FIG. 17, the latest index 118 contains “gateway-id,” “object-id,” “shadow-version,” “vin,” “location-lon,” “location-lat,” and “location-alt.”

“Gateway-id” is information identifying the mobility GW 111.

“Object-id” is information identifying a vehicle mounted with the data collection device 2.

“Shadow-version” corresponds to “Shadow_version” of the shadow 114. That is, “shadow-version” is information identifying a shadow 114 and a timestamp is set therefor.

“Vin” is a registration number specific to a vehicle mounted with the data collection device 2.

“Location-lon” is information indicating a latitude at which a vehicle mounted with the data collection device 2 exists.

“Location-lat” is information indicating a longitude at which a vehicle mounted with the data collection device 2 exists.

“Location-alt” is information indicating an altitude at which a vehicle mounted with the data collection device 2 exists.

As shown in FIG. 15, the data management portion 121 includes the index generation portion 124 and the index storage portion 125.

The index generation portion 124 regularly acquires a latest index 118 from the latest index storage portion 117 and generates an index 126 (also, referred to as second index) using the acquired latest index 118. The index generation portion 124 stores the generated index 126 in the index storage portion 125. As a result, a plurality of the indexes 126 different in generation time from vehicle to vehicle are stored in the index storage portion 125.

As shown in FIG. 18, the latest index 126 contains “timestamp,” “schedule-type,” “gateway-id,” “object-id,” “shadow-version,” “vin,” “location,” and “alt.”

“Timestamp” is a timestamp indicating time in milliseconds.

“Schedule-type” indicates whether a scheduler of a data generation source is on the regular basis or on the basis of event. In cases where the schedular is on the regular basis, “Repeat” is set for “schedule-type”; and in cases where the schedular is on the basis of event, “Event” is set for “schedule-type.”

“Gateway-id” is information identifying the mobility GW 111. “Object-id” is information identifying a vehicle mounted with the data collection device 2.

“Shadow-version” is a timestamp of a gateway and is information identifying a shadow 114. “Vin” is a registration number specific to a vehicle mounted with the data collection device 2.

“Location” is information indicating a latitude and a longitude at which a vehicle mounted with the data collection device 2 exists. “Alt” is information indicating an altitude at which a vehicle mounted with the data collection device 2 exists.

A configuration in which the latest index generation portion 116 or the latest index storage portion 117 is not provided may be adopted and the index generation portion 124 may acquire a shadow 114 stored in the shadow storage portion 112 to generate an index 126. The index generation portion 124 preferably uses a latest index 118 acquired from the latest index storage portion 117 to generate an index 126. This is one of configurations in which the mobility GW 111 and the data management portion 121 are loosely coupled with each other.

Further, a configuration in which the index generation portion 124 or the index storage portion 125 is not provided, either may be adopted. For example, an index acquisition portion 127 uses “object-id” specified by the access API 122 and a timestamp (shadow-version) to request acquisition of vehicle data specified by a data acquisition portion 119.

As shown in FIG. 15, the mobility GW 111 includes the data acquisition portion 119. The data management portion 121 includes the index acquisition portion 127.

To acquire vehicle data corresponding to a specified parameter from a shadow 114, the index acquisition portion 127 provides an index 126 by which the shadow 114 can be identified. When receiving a request instructing acquisition of specified data of a specified vehicle at specified time from the access API 122, the index acquisition portion 127 acquires an index 126 corresponding to the specified time and the specified vehicle of the received request from the index storage portion 125.

Further, the index acquisition portion 127 takes the shadow 114 identified based on the acquired index 126 as a specified shadow and sends a request instructing acquisition of specified data in the specified shadow to the data acquisition portion 119. Specifically, since the shadow 114 is uniquely determined by “object-id” and “shadow-version,” the index acquisition portion 127 uses “object-id” and “shadow-version” to request the data acquisition portion 119 to acquire the specified data.

When receiving the request from the index acquisition portion 127, the data acquisition portion 119 extracts the specified data from the specified shadow indicated by the received request and sends the extracted specified data to the access API 122. The extracted specified data may also be sent to the access API 122 through the index acquisition portion 127.

To acquire specified data of a specified vehicle at specified time, the access API 122 may acquire a relevant index 126 from the index storage portion 125 through the index acquisition portion 127 and may use the acquired index 126 (“object-id” and “shadow-version”) to request the data acquisition portion 119 to acquire the specified data.

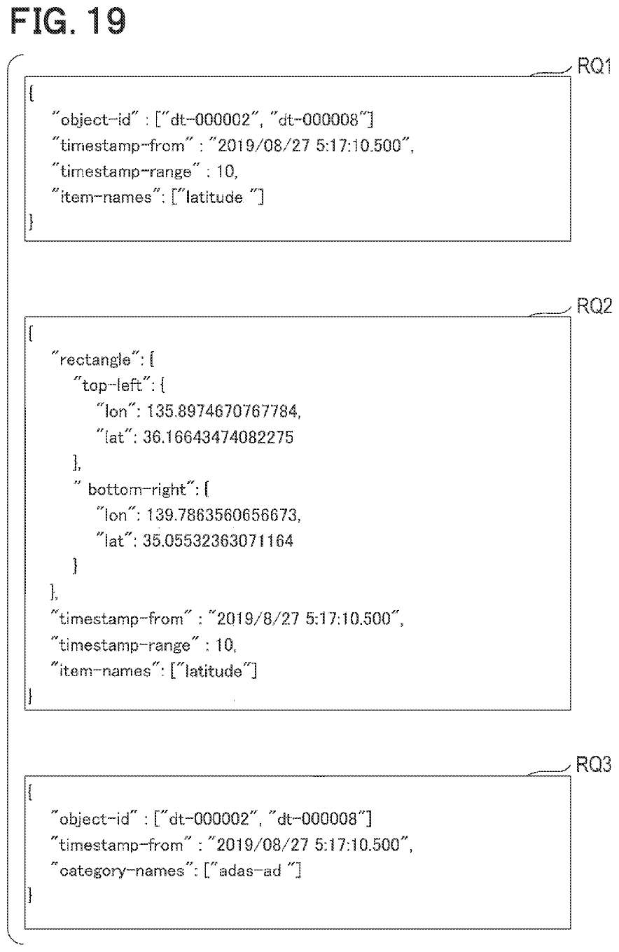

The requests RQ1, RQ2, RQ3 shown in FIG. 19 are concrete examples of requests sent to the access API 122 by the service providing server 4. In other words, the requests are APIs for vehicle data acquisition provided to the service providing server 4 by the access API 122.

The request RQ1 is a request instructing a vehicle whose “object-id” is “dt-000002” and a vehicle whose “object-id” is “dt-000008” to acquire a latitude (that is, data whose “item-names” is “latitude”) for 10 seconds from 5:17:10.5 on Aug. 27, 2019.

Through the API 122 that accepted the request RQ1, the index acquisition portion 127 acquires, from the index storage portion 125,” “shadow-version” by which a shadow 114 corresponding to “object-id” and time information can be identified. Then, the index acquisition portion 127 instructs the data acquisition portion 119 to acquire “latitude” corresponding to “object-id” and “shadow-version.” The data acquisition portion 119 acquires the relevant vehicle data from the shadow storage portion 112 and the vehicle data is sent to the access API 122.

The request RQ2 is a request instructing acquisition of a latitude of a vehicle existing in a rectangular area defined by a top-left point identified by a longitude expressed by 135.8974670767784 and an altitude expressed by 36.16643474082275 and a bottom-right point identified by a longitude expressed by 139.7863560656673 and an altitude expressed by 35.05532363071164 for 10 seconds from 5:17:10.5 on Aug. 27, 2019.

Through the access API 122 that accepted the request RQ2, the index acquisition portion 127 acquires, from the index storage portion 125, a list of “object-id” of vehicles existing in the specified area at the specified time and acquires “shadow-version” of the relevant “object-id” at the specified time. Then, the index acquisition portion 127 instructs the data acquisition portion 119 to acquire “latitude” corresponding to “object-id” and “shadow-version.” The data acquisition portion 119 acquires the relevant vehicle data from the shadow storage portion 112 and the vehicle data is sent to the access API 122.

The request RQ3 is a request instructing a vehicle whose “object-id” is “dt-000002” and a vehicle whose “object-id” is “dt-000008” to acquire information of all the entries under the category “ADAS/AD” at 5:17:10.5 on Aug. 27, 2019.

Through the API 122 that accepted the request RQ3, the index acquisition portion 127 acquires, from the index storage portion 125,” “shadow-version” by which a shadow 114 corresponding to “object-id” and time information can be identified. Then, the index acquisition portion 127 instructs the data acquisition portion 119 to acquire information of all the entries under the category of “ADAS/AD” corresponding to “object-id” and “shadow-version.” The data acquisition portion 119 acquires the relevant vehicle data from the shadow storage portion 112 and the vehicle data is sent to the access API 122.

By specifying the above analysis information as specified data of a request sent to the access API 112 by the service providing server 4, the service providing server 4 can acquire the above analysis information. For example, the index acquisition portion 127 acquires, from the index storage portion 125, an index 126 corresponding to a specified vehicle and a specified time of a received request. Further, the index acquisition portion 127 takes a shadow 114 identified based on an acquired index 126 as a specified shadow and sends, to the data acquisition portion 119, data instructing acquisition of data under the category “dangerous driving” in the specified shadow. The category “dangerous driving” contains “abrupt steering,” “heavy braking,” and “sudden acceleration” as items. As a result, the service providing server 4 can acquire data containing “abrupt steering,” “heavy braking,” and “sudden acceleration.”

As indicated by the allow L1 in FIG. 5, the service providing server 4 accesses a digital twin 123 in the data management portion 121 through the access API 122 and thereby identifies a shadow 114 corresponding to the specified vehicle. As indicated by the arrow L2 in FIG. 4, then, the service providing server 4 sends a control instruction containing the specified shadow and the contents of control to the vehicle control portion 113 of the mobility GW 111. As a result, the vehicle control portion 113 sends the control instruction to the data collection device 2 of a vehicle corresponding to the specified shadow. After the control instruction is received by the data collection device 2, control based on the control instruction is exercised at the vehicle mounted with the data collection device 2.

A data collection device of the thus configured mobility IoT system 1 is mounted in a vehicle and includes the first unit 101 and the second unit 102.

The first unit 101 includes the first core 21 and acquires a plurality of pieces of vehicle data from an electronic control unit mounted in a vehicle. The second unit 102 includes the second core 22 and is so configured as to be capable of communicating data with the management center 3 managing vehicle data.

The second unit 102 normalizes a plurality of pieces of vehicle data acquired by the first unit 101. Further, the second unit 102 structures a plurality of pieces of the normalized vehicle data in a preset data structure. The second unit 102 sends a plurality of pieces of the structured vehicle data to the management center 3 through the communication portion 13.

The data collection device 2 standardizes a plurality of pieces of acquired vehicle data and is thus capable of providing the management center 3 with vehicle data in a format independent of, for example, vehicle manufacturer, car model, or shipping timing. Further, since the data collection device 2 structures a plurality of pieces of the normalized vehicle data in a preset data structure, the vehicle data can be accessed by a data name (item name) of specific vehicle data or by a category name of a specific category. Because of the foregoing, the data collection device 2 can facilitate vehicle data utilization.

The data collection device 2 includes the flash memory 25 that can be respectively accessed by the first core 21 and the second core 22. The first unit 101 stores a plurality of pieces of acquired vehicle data in the flash memory 25 and the second unit 102 acquires the vehicle data from the flash memory 25. As a result, the data collection device 2 need not separately store a plurality of pieces of vehicle data in the first unit 101 and in the second unit 102; therefore, a storage capacity for storing data can be reduced. The data collection device 2 allows a time required for communicating data between the first unit 101 and the second unit 102 to be shortened.

The data collection device 2 references to the vehicle data conversion table 23a in which “resolution” and “offset” are established as normalization information to normalize a plurality of pieces of vehicle data. As a result, the data collection device 2 is capable of providing the management center 3 with vehicle data in a format independent of car model and vehicle manufacturer.

The vehicle data conversion table 23a further contains meaning-giving information for conversion into vehicle data generated using a plurality of pieces of normalized vehicle data. The data collection device 2 further generating meaning-given vehicle data from a plurality of pieces of the normalized vehicle data using the meaning-giving information. As a result, the data collection device is capable of providing the management center 3 with vehicle data given a meaning using vehicle data acquired from a vehicle.

Further, the data collection device 2 structures a plurality of pieces of normalized vehicle data in a data structure classified by a plurality of categories. As a result, the data collection device 2 enables the management center 3 to access a plurality of pieces of vehicle data by a data name of specific vehicle data or by a category name of a specific category.

When receiving a CAN frame containing at least one piece of vehicle data from an electronic control unit, the first unit 101 extracts CAN ID and first to eighth data from the CAN frame, generates standard format data comprised of the extracted CAN ID and first to eighth data, and stores vehicle data formed as standard format data in the flash memory 25. As a result, the data collection device 2 does not send data unnecessary for the management center 3 to the management center 3 and a communication processing load can be reduced.

For each piece of structured vehicle data, any one of a plurality of pieces of transmission timing different from one another is set. The data collection device 2 sends each of a plurality of pieces of the vehicle data with transmission timing set for the vehicle data. As a result, the data collection device 2 is capable of reducing a frequency of useless transmission of vehicle data that has not been updated and thus a communication processing load can be reduced.

The first unit 101 includes the first application 104 executing processing for controlling a vehicle. The second unit 102 includes the second application 106 that performs processing related to services provided by the service providing server 4 connected with the management center 3 in such a manner that data can be communicated. The flash memory 25 holds a plurality of pieces of structured vehicle data. The first application 104 and the second application 106 are so configured that the applications can access the flash memory 25. As a result, the data collection device 2 need not separately store a plurality of pieces of vehicle data in the first unit 101 and in the second unit 102; therefore, a storage capacity for storing data can be reduced.

The vehicle control portion 113 may acquire a control instruction from the service providing server 4 through the access API 122 of the service-side unit 120. That the service-side unit 120 is provided with the access API 122 and the vehicle-side unit 110 is provided with the vehicle control portion 113 is also one of configurations in which the two units are loosely coupled with each other.

The first unit 101 acquires a plurality of pieces of vehicle data from the ECU 210 that is transmissibly connected with a plurality of the ECUs 220, a plurality of the ECUs 230, and the external communication device 240. As a result, the data collection device 2 need not directly communicate with the ECUs 220, ECUs 230, or external communication device and a configuration for the data collection device 2 to conduct communication can be simplified.

The data collection device 2 includes the standardized vehicle data storage portion 25a holding a plurality of pieces of structured vehicle data (that is, standardized vehicle data). The second application 106 acquires vehicle data stored in the standardized vehicle data storage portion 25a through the vehicle access API 107 provided in the second unit 102. As a result, the second application 106 installed in the data collection device 2 can reference to the vehicle data.

The management center 3 includes the communication portion 32, and the storage portion 33. The communication portion 32 receives a plurality of pieces of structured vehicle data (that is, standardized vehicle data) sent from a plurality of the data collection devices 2. The storage portion 33 stores a plurality of pieces of structured vehicle data received by the communication portion 32 on a vehicle-by-vehicle basis.

The management center 3 accepts a request from the service providing server 4 connected with the management center 3 in such a manner that data can be communicated through the access API 122 provided in the management center 3 and sends a plurality of pieces of vehicle data corresponding to a plurality of vehicles stored in the storage portion 33. As a result, the mobility IoT system 1 can provide vehicle data to the service providing server 4 on a vehicle-by-vehicle basis.

In the above-mentioned embodiment, the data collection device 2 is equivalent to an in-vehicle device; the management center 3 is equivalent to a center; and the service providing server 4 is equivalent to a service providing unit.

S40 is equivalent to processing of a normalization portion; S50 is equivalent to processing of a data structuring portion; S110 to S340 are equivalent to processing of a data transmission portion; the communication portion 13 is equivalent to a communicator; and the flash memory 25 is equivalent to a shared memory.

The CAN frame is equivalent to a communication frame; the CAN ID is equivalent to frame identification information; and the first to eighth data is equivalent to vehicle data.

The ECU 210 is equivalent to a relaying device; the standardized vehicle data storage portion 25a is equivalent to a storage portion; and the vehicle access API 107 is equivalent to an in-vehicle device access API.

The mobility IoT system 1 is equivalent to a vehicle system; the communication portion 32 is equivalent to a data reception portion; the storage portion 33 is equivalent to a vehicle data storage portion; the access API 122 is equivalent to a center access API; and the second application 106 is equivalent to an application of the in-vehicle device.

Up to this point, a description has been given to an embodiment of the present disclosure but the present disclosure is not limited to the above-mentioned embodiment and can be variously modified when implemented.

The microcomputer 11 and a technique thereof described in the present disclosure may be implemented by a dedicated computer provided by configuring a processor and a memory so programmed as to perform one or more functions materialized by a computer program. Or, the microcomputer 11 and a technique thereof described in the present disclosure may be implemented by a dedicated computer provided by configuring a processor of one or more dedicated hardware logic circuits. Alternatively, the microcomputer 11 and a technique thereof described in the present disclosure may be implemented by one or more dedicated computers configured of a combination of a processor and a memory so programmed as to perform one or more functions and a processor configured of one or more hardware logic circuits. A computer program may be stored in a computer-readable non-transitional tangible recording medium as an instruction executed by a computer. A technique for performing the functions of each part included in the microcomputer 11 need not include software and all the functions thereof may be conducted using one or more pieces of hardware.

A plurality of functions of one component in the above-mentioned embodiment may be conducted by a plurality of components and one function of one component may be implemented by a plurality of components. A plurality of functions of a plurality of components may be conducted by one component and one function conducted by a plurality of components may be conducted by one component. A part of a configuration of the above-mentioned embodiment may be omitted. At least a part of a configuration the above-mentioned embodiment may be added to or replaced with a configuration of any other embodiment.

Aside from the above-mentioned data collection device 2, the present embodiment can also be implemented in various modes including a system including the data collection device 2 as a component, a program for causing a computer to function as the data collection device 2, a non-transitional tangible recording medium, such as a semiconductor memory, recording the program, a vehicle data generation method, and the like.

1. An in-vehicle device mounted in a vehicle, the in-vehicle device comprising:
at least one processor; and
at least one memory storing computer program code, wherein
the computer program code, when executed by the at least one processor, causes the at least one processor to serve as a unit that is configured to communicate data with a center configured to manage vehicle data,
the unit includes:
a normalization portion that is configured to normalize a plurality of pieces of the vehicle data acquired from an electronic control unit mounted in the vehicle;
a data structuring portion that is configured to structure the plurality of pieces of the vehicle data that are normalized by the normalization portion into a predetermined data structure; and
a data transmission portion that is configured to transmit the plurality of pieces of the vehicle data that are structured by the data structuring portion to the center through a communicator.

2. The in-vehicle device according to claim 1, wherein
the at least one processor includes a first core and a second core,
the computer program code, when executed by the first core, further causes the first core to serve as a first unit that is configured to acquire the plurality of pieces of the vehicle data from the electronic control unit,
the computer program code, when executed by the second core, further causes the second core to serve as the unit as a second unit,
the in-vehicle device further comprises a shared memory to which the first core and the second core are accessible,
the first unit is configured to store the plurality of pieces of the acquired vehicle data on the shared memory, and
the second unit is configured to acquire the plurality of pieces of the vehicle data from the shared memory.

3. The in-vehicle device according to claim 1, wherein
the normalization portion is further configured to normalize the plurality of pieces of the vehicle data by referring to a vehicle data conversion table in which “resolution” and “offset” are set as normalization information.

4. The in-vehicle device according to claim 3, wherein
the vehicle data conversion table further includes meaning-giving information that is generated using the plurality of pieces of the vehicle data that are normalized,
the meaning-giving information is used for conversion into the vehicle data, and
the normalization portion is further configured to generate, using the meaning-giving information, meaning-given vehicle data from the plurality of pieces of the normalized vehicle data.

5. The in-vehicle device according to claim 1, wherein
the data structuring portion is further configured to structure the plurality of pieces of the vehicle data that are normalized into the data structure classified with a plurality of categories.

6. The in-vehicle device according to claim 1, wherein
the at least one processor includes a first core and a second core,
the computer program code, when executed by the first core, further causes the first core to serve as a first unit that is configured to acquire the plurality of pieces of the vehicle data from the electronic control unit,
the computer program code, when executed by the second core, further causes the second core to serve as the unit as a second unit,
the in-vehicle device further comprises a shared memory to which the first core and the second core are accessible, and
upon receiving a communication frame storing at least one of the plurality of pieces of the vehicle data from the electronic control unit, the first unit is configured to:
extract frame identification information and the vehicle data from the received communication frame;
generate standard format data formed of the extracted frame identification information and the extracted vehicle data; and
store the vehicle data in the standard format data on the shared memory.

7. The in-vehicle device according to claim 1, wherein
each of a plurality of mutually different transmission timings is set for a respective one of the plurality of pieces of the vehicle data that are structured, and
the data transmission portion is further configured to transmit each of the plurality of pieces of the structured vehicle data at a corresponding one of the plurality of mutually different transmission timings.

8. The in-vehicle device according to claim 1, wherein
the at least one processor includes a first core and a second core,
the computer program code, when executed by the first core, further causes the first core to serve as a first unit that is configured to acquire the plurality of pieces of the vehicle data from the electronic control unit,
the computer program code, when executed by the second core, further causes the second core to serve as the unit as a second unit,
the in-vehicle device further comprises a shared memory to which the first core and the second core are accessible,
the first unit includes a first application that is configured to execute a process to control the vehicle,
the second unit includes a second application that is configured to execute a process related to a service provided by a service providing unit that is communicably connected to the center,
the plurality of pieces of the vehicle data that are structured by the data structuring portion are stored on the shared memory, and
the first application and the second application are configured to be accessible to the shared memory.

9. The in-vehicle device according to claim 1, wherein
the at least one processor includes a first core and a second core,
the computer program code, when executed by the first core, further causes the first core to serve as a first unit that is configured to acquire the plurality of pieces of the vehicle data from the electronic control unit,
the computer program code, when executed by the second core, further causes the second core to serve as the unit as a second unit, and
the first unit is configured to acquire the plurality of the vehicle data from a relaying device that is communicably connected to the electronic control unit.

10. The in-vehicle device according to claim 8, further comprising:
a storage portion that is configured to store the plurality of pieces of the vehicle data that are structured by the data structuring portion, wherein
the second application is configured to acquire the vehicle data stored in the storage portion through an in-vehicle device access API provided in the second unit.

11. A data generation method implemented by an in-vehicle device that is mounted in a vehicle and includes a unit that is configured to communicate data with a center configured to manage vehicle data, the method comprising:
normalizing a plurality of pieces of the vehicle data acquired from an electronic control unit mounted in the vehicle;
structuring the plurality of pieces of the vehicle data that are normalized into a predetermined data structure; and
transmitting, with the unit, the plurality of pieces of the vehicle data that are structured to the center through a communicator.

12. A non-transitory, tangible storage medium for storing a data generation program for an in-vehicle device that is mounted in a vehicle and includes a unit that is configured to communicate data with a center configured to manage vehicle data, the data generation program, when executed by a computer of the in-vehicle device, causing the computer to:
normalize a plurality of pieces of the vehicle data acquired from an electronic control unit mounted in the vehicle;
structure the plurality of pieces of the vehicle data that are normalized into a predetermined data structure; and
cause the unit to transmit the plurality of pieces of the vehicle data that are structured to the center through a communicator.

13. A vehicle system, comprising:
a center that is configured to manage vehicle data transmitted from a plurality of vehicles; and
a plurality of in-vehicle devices that are configured to wirelessly communicate with the center through a communicator, wherein
each of the plurality of in-vehicle devices includes:
at least one processor; and
at least one memory storing computer program code,
the computer program code, when executed by the at least one processor, causes the at least one processor to serve as a unit that is configured to communicate data with the center,
the unit includes:
a normalization portion that is configured to normalize a plurality of pieces of the vehicle data acquired from an electronic control unit mounted in the vehicle;
a data structuring portion that is configured to structure the plurality of pieces of the vehicle data that are normalized by the normalization portion into a predetermined data structure; and
a data transmission portion that is configured to transmit the plurality of pieces of the vehicle data that are structured by the data structuring portion to the center through the communicator, and
the center includes:
a data receiving portion that is configured to receive the plurality of pieces of the structured vehicle data transmitted from the plurality of in-vehicle devices; and
a vehicle data storage portion that is configured to store, for each of the plurality of vehicles, the plurality of pieces of the vehicle data that are structured by the data structuring portion and received by the data receiving portion.

14. The vehicle system according to claim 13, wherein
each of the plurality of in-vehicle devices includes a storage portion that is configured to store the plurality of pieces of the vehicle data that are structured by the data structuring portion.

15. The vehicle system according to claim 14, wherein
each of the plurality of in-vehicle devices has an application that is configured to acquire the plurality of pieces of the vehicle data stored in the storage portion through an in-vehicle device access API provided in each of the plurality of in-vehicle devices.

16. The vehicle system according to claim 13, wherein
the center is further configured to:
accept a request from a service providing unit communicably connected to the center through a center access API provided in the center; and
transmit, to the service providing unit, the plurality of pieces of the vehicle data, which are stored in the vehicle data storage portion and each of which corresponds to a respective one of the plurality of vehicles.

17. An in-vehicle system, comprising:
an electronic control unit that is mounted in a vehicle and is configured to transmit vehicle data;
an in-vehicle device that is configured to acquire the vehicle data transmitted from the electronic control unit, wherein
the in-vehicle device includes:
at least one processor; and
at least one memory storing computer program code, wherein
the computer program code, when executed by the at least one processor, causes the at least one processor to serve as a unit that is configured to communicate data with a center configured to manage vehicle data,
the unit includes:
a normalization portion that is configured to normalize a plurality of pieces of the vehicle data acquired from the electronic control unit mounted in the vehicle;
a data structuring portion that is configured to structure the plurality of pieces of the vehicle data that are normalized by the normalization portion into a predetermined data structure; and
a data transmission portion that is configured to transmit the plurality of pieces of the vehicle data structured by the data structuring portion to the center through a communicator.
